(19) United States
(12) Patent Application Publication
(10) Pub. No.: US 2024/0065158 A1
(43) Pub. Date: Feb. 29, 2024

(54) POWERED STONE BARRIER

(71) Applicant: Ploeger Oxbo Holding B.V., Roosendaal (NL)

(72) Inventors: Abe Bensend, Boyceville, WI (US); Tyler Olson, Hammond, WI (US)

(21) Appl. No.: 18/300,901

(22) Filed: Apr. 14, 2023

Related U.S. Application Data
(60) Provisional application No. 63/401,898, filed on Aug. 29, 2022.

(51) Int. Cl. A01D 41/14; A01D 34/03

(52) U.S. Cl. CPC A01D 41/14; A01D 34/035

(57) ABSTRACT

A combine harvester includes a chassis and a head including a reel rotating about an axis substantially perpendicular to a direction of travel. A front portion of the head includes a cutter. A crop feeder system transports cut crop from the cutter along the head and to the combine harvester processing systems. A powered movable stone barrier is rearward of the cutter and moves in a laterally reciprocating motion.

### BACKGROUND OF THE INVENTION

### Field of the Invention

The present invention relates to a grain conveying auger system and in particular to an improved movable stone barrier mounted proximate a cutter bar and providing agitation to achieve improved transport efficiency of cut crop.

### Description of the Prior Art

Harvesters such as combine harvesters for harvesting crops are well known. Combine harvesters are well known in the art. In harvesting cereal grains and other crops, cutter bars, such as reciprocating sickle bars, are often utilized along with a reel, conveyors and/or augers in a conveyor system on the combine harvester head. However, in low-growing crops, such as soybeans, it is advantageous to cut the crops as close to the ground as possible to increase crop yield.

Although such conveying systems generally perform satisfactorily, problems can occur. With cutter bars, rocks and dirt tend to enter the harvesting apparatus during operation and cause damage to various mechanisms, resulting in significant downtime and repair. To prevent this damage, stone dams, also known as stone barriers or deflectors have been developed. Such stone dams or deflectors are shown in U.S. Pat. Nos. 4,156,338 and 6,070,401. These devices allow passage of the crop, but the devices deflect rocks and foreign objects from entering into the combine mechanism.

Although the stone barriers reduce the occurrence of rocks and other objects from being conveyed, the stone dams have some drawbacks. Such stone dams may collect crop in front of the dam. For test plot harvesters, the efficient transport of crops in a timely and efficient manner becomes more critical, as the crop harvested for each plot is closely measured and any crop remaining in the conveying system pan would lead to the yield being under measured. Any crop that collects at the stone dam, without being processed for the other crop from a test plot may result in mixing, which affects the data quality including yield for seed researchers analyzing individual plots.

It can be seen that a new and improved stone dam system is needed to efficiently transport crops including grains harvested with a reel type harvester from a cutter bar without transporting rocks and other foreign objects. Such a system should ensure that there is no buildup of grains along the stone dam deflector. Such a system should ensure that the stone dam is continuously cleared of crop and debris so that a batch of grain from each test plot is completely cleared from the stone dam and the yield is accurately measured. The present invention addresses these as well as other problems associated with efficiently transporting crop material in a crop conveying system.

### SUMMARY OF THE INVENTION

The present invention is directed to a combine harvester and a head for a combine harvester, and in particular to a combine harvester and head cutter assembly having a moving stone barrier. The combine harvester includes a head having a reel rotating about an axis substantially perpendicular to a direction of travel. The head may be foldable and may be configured with two wings, with each wing being adapted for independently harvesting a crop test plot. The head includes a cutter, such as a sickle bar at a front portion of the head.

In one embodiment, each wing includes a includes a cutter assembly at a lower forward edge of the wing to engage and cut crop. The cutter assembly includes a cutter, such as a reciprocating sickle bar and a rock dam, also referred to as a stone barrier. The cutter assembly includes a knife guard with laterally spaced apart spike like projections (tines) along the forward edge of the wing. The tines engage and direct materials against elements of the cutter assembly. A skid shoe slopes rearward below the cutter assembly and engages the ground to help the wing pass over uneven terrain and obstacles.

The wing may include a sickle bar assembly and a stone barrier assembly. In one embodiment, the sickle bar assembly includes the sickle bar composed of individual sickle bar sections that are held between spacer plates and the stone barrier assembly. The individual sickle bar sections are interchangeable and may be removed and replaced with new sickle bar sections should they be damaged or require sharpening. The knife guards form a laterally extending channel for receiving the sickle bar. The channel provides a passage for the sickle bar to move in a laterally reciprocating manner.

The stone barrier assembly includes a stone barrier plate and a stone barrier extension. The stone barrier plate includes a horizontal extending section mounting on an upper surface of the sickle bar and an angled upward and rearward extending portion at the rear of the horizontal portion. In one embodiment, the stone barrier extension includes an angled forward portion mounting to the rear of the complementary angled portion of the stone barrier plate and a rear portion extending horizontally rearward from an upper edge of the forward portion. A knife connector is at one end of the sickle bar and stone barrier assembly adjacent one end of the stone barrier and includes a connector element ring for receiving an engagement member of a motor assembly. Channel members mount at the ends of the sickle bar and stone barrier assembly and provide additional lateral barrier coverage.

The sickle bar and stone barrier assembly according to one embodiment is a movable assembly and is driven by a motor assembly including a hydraulic motor or other conventional motor. In one embodiment the motor has a driveshaft that connects to a planetary gearbox including a mounting plate or flange. The gearbox has a planetary coupling housing supported by a planetary housing mounting plate. An arm extends into the that connector receiving ring. Rotation of the arm drives the cutter bar and stone barrier assembly in a lateral back-and-forth motion.

In operation, the harvester advances along a crop field and the rotating reel gathers crop and pulls it toward the cutter assembly. As the harvester advances and the reel gathers crop, the sickle type cutter bar moves laterally back and forth to cut the upper part of the crop from that remaining attached to soil. In addition, the stone barrier assembly, which is connected to the sickle bar assembly, also moves laterally back and forth. The upper cut portion of the crop is directed further rearward by the reel toward the feed belt and to the combine for threshing and further processing. This reciprocating motion was found to improve separation of the crop from the rock and other debris and to quickly disperse the debris from the cutter assembly without the debris passing over the stone barrier assembly and being mixed with crop in the combine harvester (100). The slope of the stone barrier plate combined with the rearward extending stone barrier extension creates a barrier that is sufficient to allow lighter crop material to pass over the stone barrier assembly while providing sufficient resistance to rocks and other debris to prevent passage of the debris over and beyond the stone barrier. The addition of motion and agitation by the stone barrier accelerates the continuous purging of debris from the wing and increases the purity of the crop that is collected. The slope of the face of the stone barrier plate is less than vertical, with a limited height and the stone barrier extension has a minimal depth to enable the crop to pass over the stone barrier assembly for further transport while repelling debris.

These features of novelty and various other advantages that characterize the invention are pointed out with particularity in the claims annexed hereto and forming a part hereof. However, for a better understanding of the invention, its advantages, and the objects obtained by its use, reference should be made to the drawings that form a further part hereof, and to the accompanying descriptive matter, in which there is illustrated and described a preferred embodiment of the invention.

### BRIEF DESCRIPTION OF THE DRAWINGS

FIG. 1 is a perspective view of a combine harvester according to the principles of the present invention;

FIG. 2 is a perspective view of a right wing of the head for the harvester shown in FIG. 1;

FIG. 3 is a front elevational view of the wing shown in FIG. 2;

FIG. 4 is top plan view of the wing shown in FIG. 2;

FIG. 5 is a sectional view of the wing taken along line 5-5 of FIG. 4;

FIG. 6 is a side detail view of the wing of FIG. 5 showing the cutter assembly for the wing shown in FIG. 2;

FIG. 7 is a perspective view of the cutter assembly for the wing shown in FIG. 2;

FIG. 8 is a front elevational view of the cutter assembly shown in FIG. 7;

FIG. 9 is a top plan view of the cutter assembly shown in FIG. 7;

FIG. 10 is an end view of the cutter assembly shown in FIG. 7;

FIG. 11 is an exploded perspective view of the cutter assembly shown in FIG. 7;

FIG. 12 is a perspective view of a sickle bar and stone barrier assembly;

FIG. 13 is a front elevational view of the sickle bar and stone barrier assembly shown in FIG. 12;

FIG. 14 is a top plan view of the stone barrier shown in FIG. 11;

FIG. 15 is an end view of the sickle bar and stone barrier assembly shown in FIG. 12;

FIG. 16 is a partially exploded view of the sickle bar and stone barrier assembly shown in FIG. 12; and

FIG. 17 is a partially exploded end view of the sickle bar and stone barrier assembly shown in FIG. 15.

### DETAILED DESCRIPTION OF THE PREFERRED EMBODIMENT

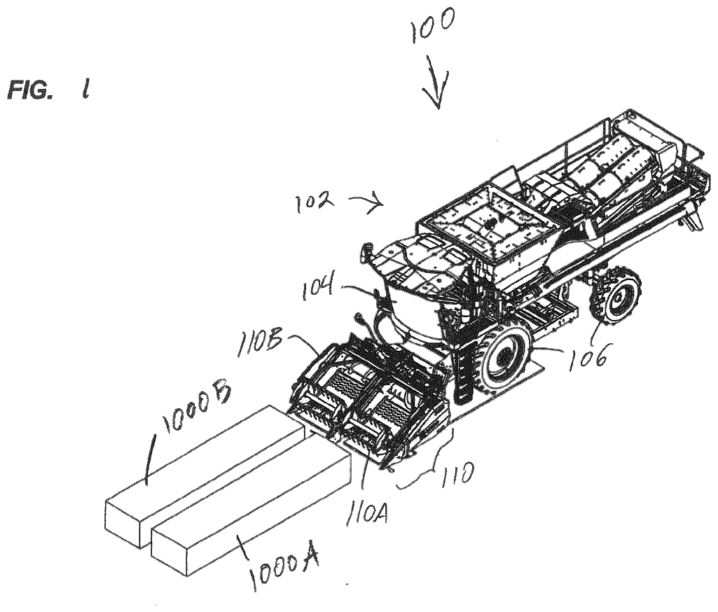

Referring now to the drawings, and in particular to FIG. 1, there is shown a reel type combine harvester, generally designated (100). In one embodiment, the combine harvester (100) is configured as a crop test plot combine, such as the Oxbo ° Model 9840 Research Plot Combine. The combine harvester (100) has a chassis (102) including all the components for processing harvested crop and recording data pertaining to the characteristics and the yield for each particular crop plot. In the embodiment shown, the combine harvester (100) is a twin plot combine with a head assembly (110) including a first head portion, or wing (110A) on the left side when looking forward along a direction of travel and a second head portion, or wing (110B) on the right side when viewed looking toward the direction of travel. The wing (110A) is adapted to align with a conventional configuration of a first (left) crop test plot (1000A) while the wing (110B) is adapted to align with a second (right) crop test plot (1000B). The twin wing head assembly (110) is removably mounted to be interchangeable with other heads, such as a corn head, so that the combine harvester (100) may be used with a variety of different crops. The reel type head assembly (110) is typically used for crops such as wheat, canola, sorghum, and soybeans, among others. The combine harvester (100) also includes tracks or wheels (106) and is typically self-propelled. An operator sits in an elevated cab (104) that provides the operator with a clear view of the crop and the head assembly (110) for steering and operating controls.

The head assembly (110) is configured to process each crop plot individually. Therefore, the combine (100) uses a separate reel (120) on each of the wings (110A, 100B) to harvest the crop of an associated first crop test plot. The crop is transported from each wing (110A, 110B) and passed through the processing equipment of the combine (100). The characteristics of the crop will be measured and evaluated with the data recorded with on board equipment. In the embodiment shown in FIG. 1, the first crop test plot (1000A) and the second crop test plot (1000B) are separated and are processed separately. Each crop test plot is individually processed and analyzed, and the results of the analysis are stored in a processor. For crop test plot combines, the individual crop test plots must be harvested individually without harvested crop being mixed together to obtain accurate results. Moreover, it is critical that all harvested crop material be transported for processing so that accurate yields are determined. The crop of a test crop plot must be harvested and sufficiently processed to ensure that there is no mixing before moving forward to a next crop test plot.

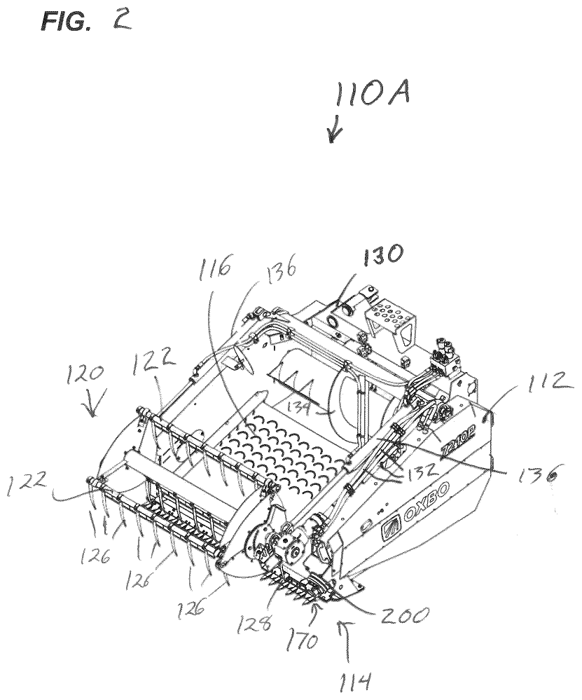

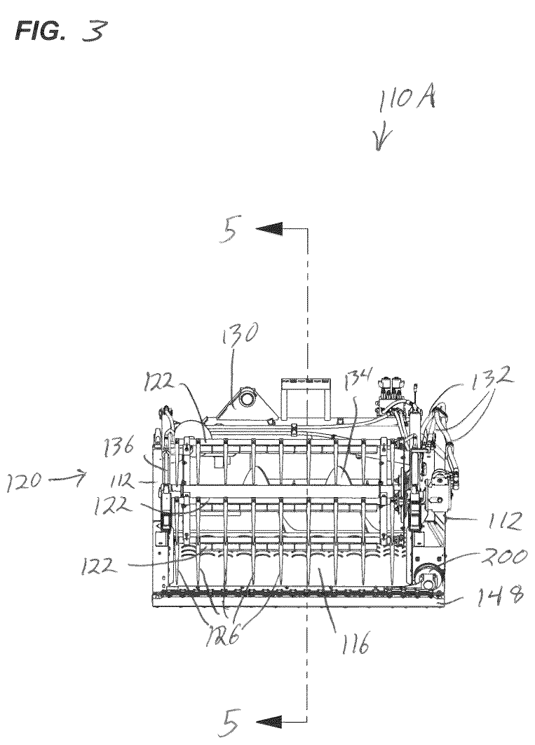

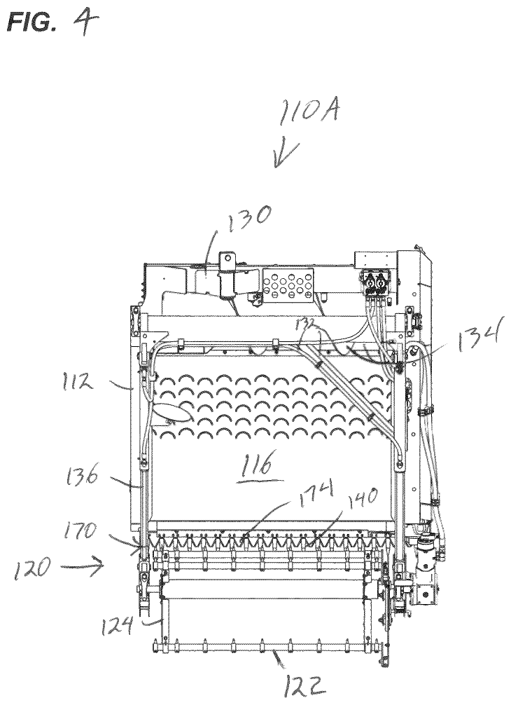

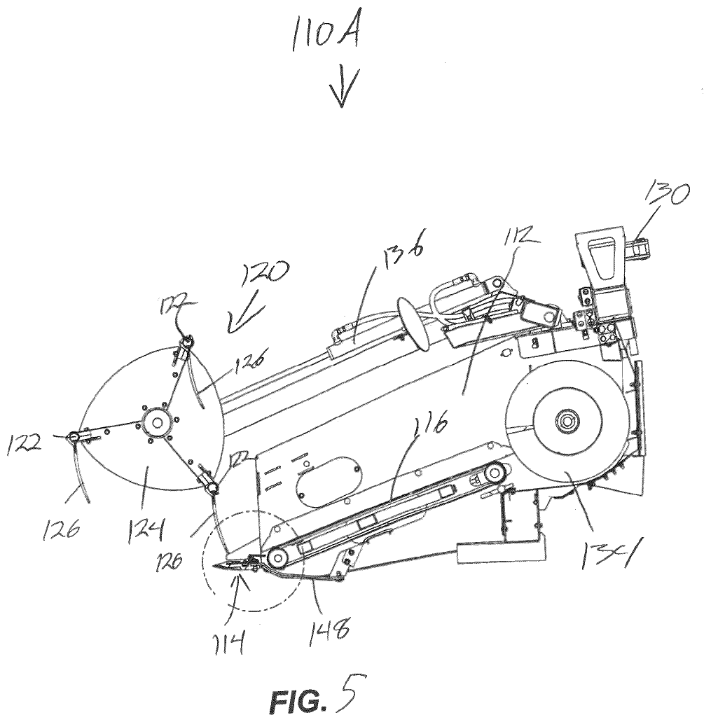

The right wing assembly (110A) is shown in FIGS. 2-5. Although the right wing is described, the left wing assembly includes corresponding components, but the left wing assembly is configured in an arrangement that substantially mirrors the right wing assembly. Each of the wings (110A, 110B) includes a framework (112) that creates a housing for the other elements. A cutter assembly (114), typically a sickle bar cutter or other conventional cutters as may be appropriate for the crop, are at the front of each wing (110A, 110B) below the reel (120). Feed belts (116) move the crop from the reel (120) rearward. Augers (134) or other transverse feeders, such as cross belts, move the harvested materials inward from the back of the feed belts (116). The reels (120) rotate about an axis substantially perpendicular to a direction of travel and include horizontally extending bars (122) that rotate and push the plants past the cutting assembly (114) and gather the cut portions onto the feed belt (116). The reel bars (122) are mounted on end plates (124). In the embodiment shown, each reel (120) includes six horizontal reel bars (122), but other numbers of bars and/or reels having a larger or smaller diameter are also envisioned. In the embodiment shown, each of the bars includes a plurality of spaced apart fingers (126) that aid in engaging the plants and extend generally transverse to the horizontal reel bars (122), which extend parallel to the rotational axis of the reels (122) transverse to the direction of travel.

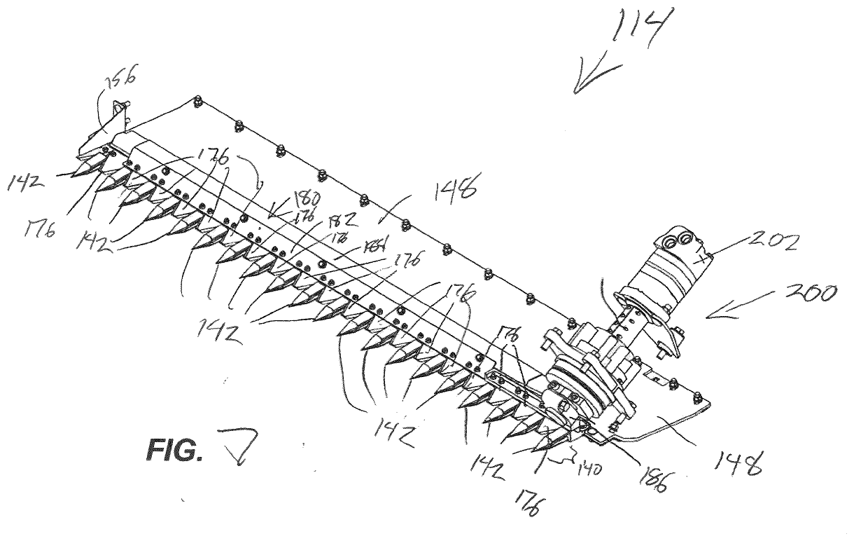

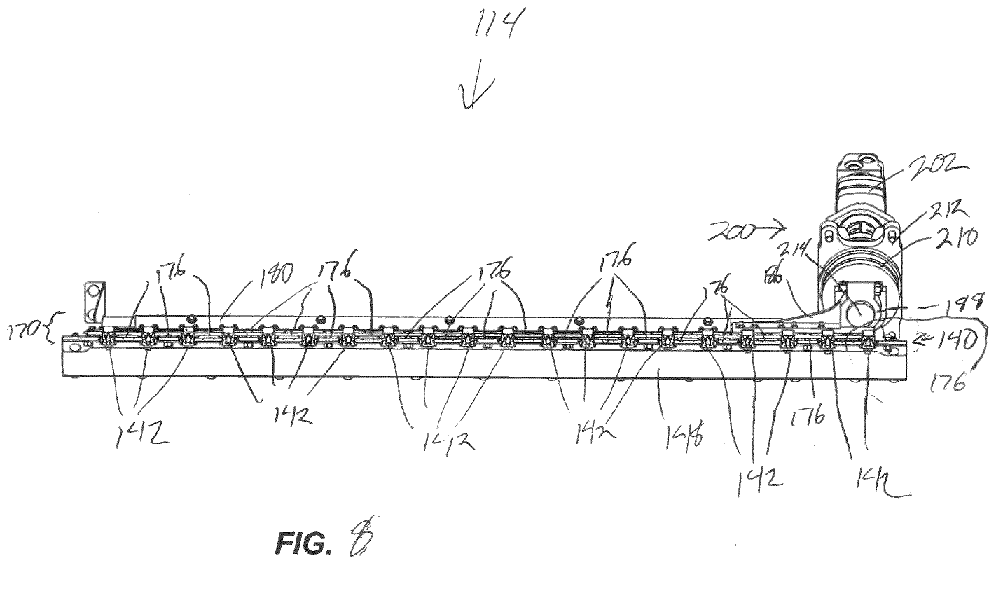

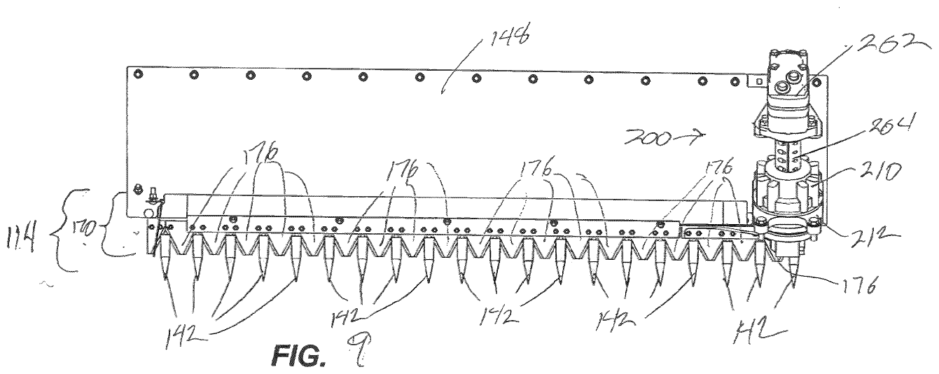

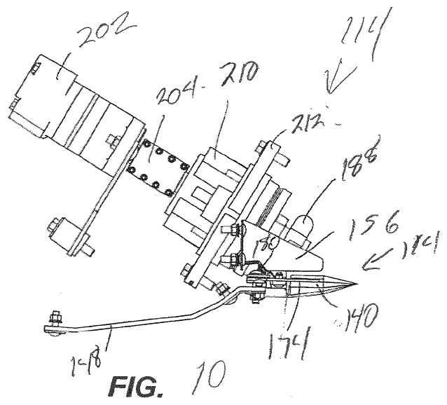

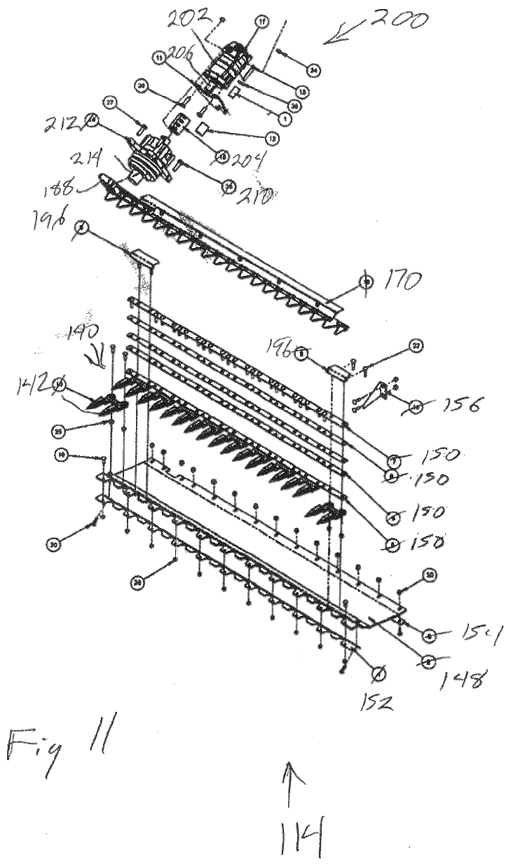

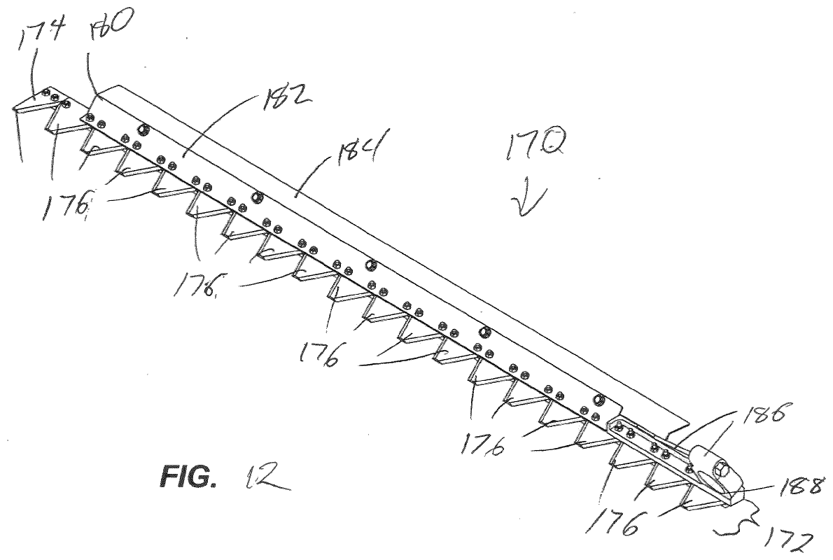

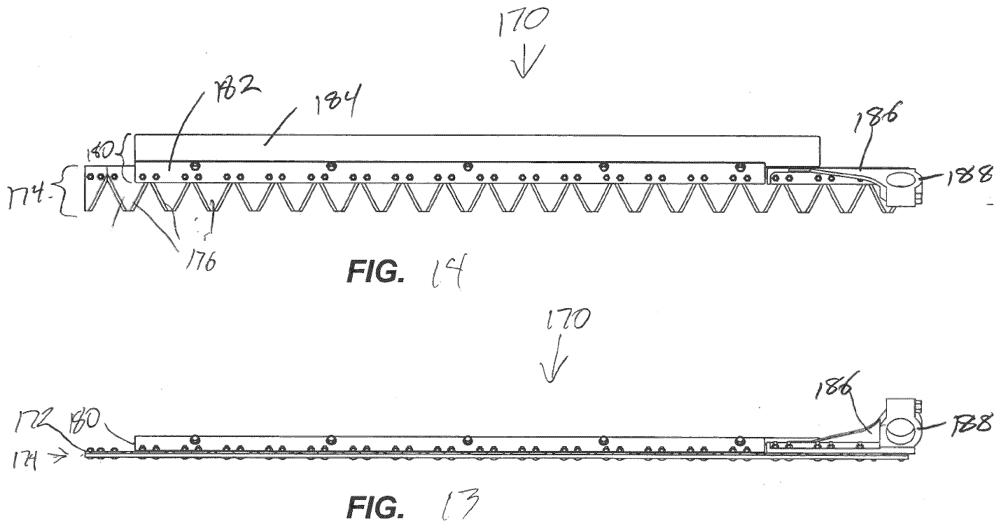

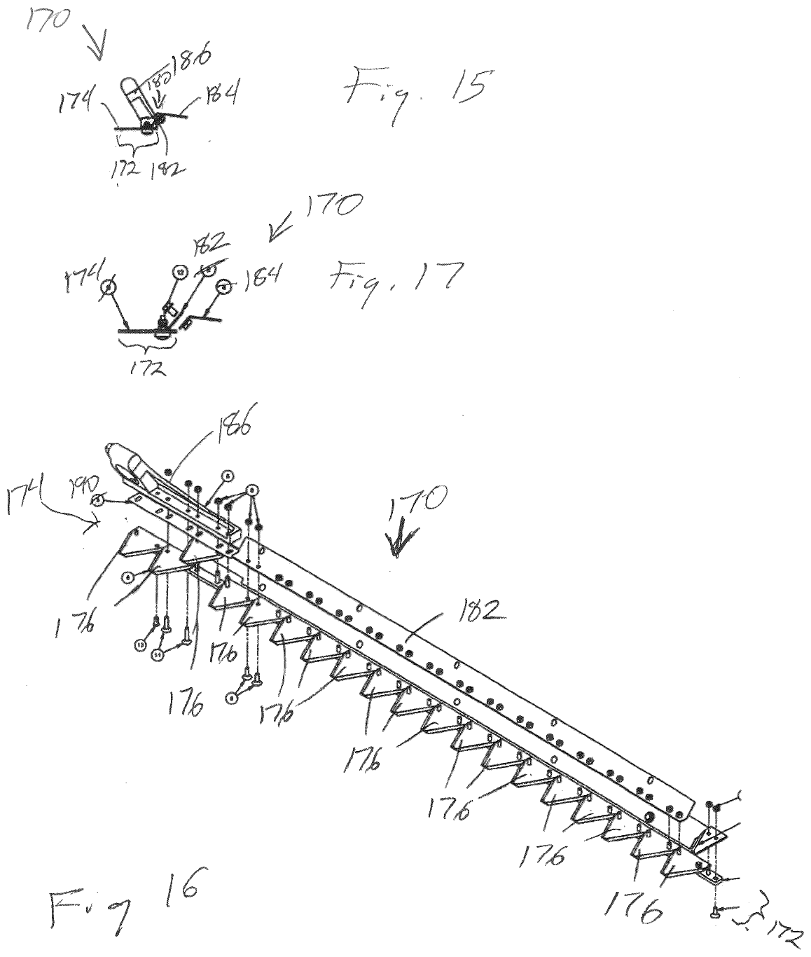

The front of each wing (110A, 110B) includes a cutter assembly (114). The cutter assembly (114) is at a lower forward edge of the wing to engage and cut crop. The cutter assembly (114) includes a reciprocating sickle bar and stone barrier assembly (140), shown more clearly in FIGS. 12-17. Referring to FIGS. 6-11, the cutter assembly (114) has a knife guard (140) with tines (142) extending forward and spaced laterally apart along the forward edge of the wing (110A, 110B). Each tine (142) includes spike like projection extending substantially horizontally forward. The tines (142) engage and direct materials to the sickle bar and stone barrier assembly (170). The knife guards (140) are formed by knife guard units (146), as shown in FIG. 11, each unit (146) including a pair of tines (142). A skid shoe (148) extends rearward from the cutter assembly (114) and engages the ground to properly position the wing (110A, 110B) and maintain the cutter bar (114) a required minimum height over the ground. The skid shoe (148) provides a sloping lower surface to engage the ground to facilitate sliding over uneven terrain and obstacles. As shown in FIG. 11, the cutter assembly (114) includes spacer plates (150) that may be stacked to provide proper spacing between the components and more particularly between the knife guards (140) and the sickle bar and stone barrier assembly (170). A front holder plate (152) and a rear hold down plate (154) extend below the skid shoe (148).

As shown in FIG. 6, the knife guard tines (142) form a channel (158) through the knife guards (140). The channel (158) is configured for receiving a sickle bar (174) of a sickle bar assembly (172). The channel (158) provides a passage for the sickle bar (174) laterally reciprocating action, as explained hereinafter.

Referring now to FIGS. 12-17, the sickle bar and stone barrier assembly (170) includes a sickle bar assembly (172) and a stone barrier assembly (180). The sickle bar assembly (172) includes the sickle bar (174). The sickle bar (174) includes individual sickle bar sections (176) that are held between the spacer plates (150) and the stone barrier assembly (180). The individual sickle bar sections (176) may be removed and replaced with new sickle bar sections (176) should they be damaged or require sharpening.

The stone barrier assembly (180) includes a stone barrier plate (182) and a stone barrier extension (184). The stone barrier plate (182) mounts on top of the sickle bar (174). The stone barrier plate (182) includes a horizontal extending section on upper surface of the sickle bar (174) and an angled upward and rearward extending portion at the rear of the horizontal portion. The stone barrier extension (184) includes an angled forward portion mounting to the rear of the angled portion of the stone barrier plate (182) and a horizontally extending rear portion. A knife connector element (186) is at one end of the sickle bar and stone barrier assembly (170) adjacent one end of the stone barrier and includes a connector element ring (188) for receiving an engagement member as explained hereinafter. As shown in FIG. 11, channel members (196) and (198) mount at the ends of the sickle bar and stone barrier assembly (170) and provide additional lateral barrier coverage.

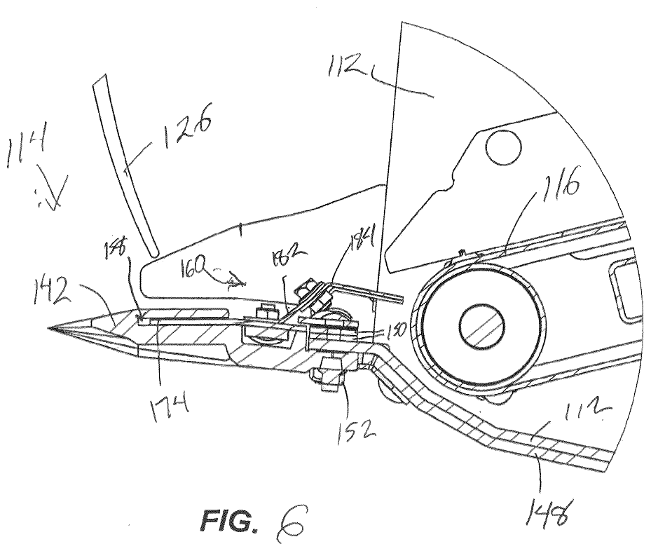

The sickle bar and stone barrier assembly (170) according to the present invention is a movable assembly and is driven by a motor assembly (200). As shown in FIG. 7-11, the motor assembly (200) includes a hydraulic motor (202). The motor has a driveshaft (206) that connects to a coupling (204). The motor coupling (204) has a planetary gearbox (210) supported by a planetary housing mounting plate (212). As shown in FIG. 11, an arm (214) extends into the connector receiving ring (188). By rotating the arm (214), the ring (188) is driven in a lateral back-and-forth motion, which also moves the attached cutter bar and stone barrier assembly (170) in the same motion. It is appreciated that the sickle bar assembly (170) and the stone barrier assembly (180) are driven by a single motor (202).

In operation, the harvester (100) advances along a crop test plot or field and the reel (120) gathers crop and pulls it toward the cutter assembly (114). With the reel (120), the tines (142) of the knife guards (140) ensure the crops is engaged by the sickle bar (174) and cleanly cut. The upper cut portion of the crop is directed further rearward by the reel (120) toward the feed belt (116) and to the chassis (102) for threshing and further processing. The sickle type cutter bar (174) moves laterally back and forth to facilitate clean separation of the upper part of the crop from that remaining attached to soil. In addition, the stone barrier assembly (180), which is connected to the sickle bar assembly (172), also moves laterally back and forth. This reciprocating motion was found to improve the separation of the crop from the rock and other debris and to quickly disperse the debris from the cutter assembly (114) without passing over the stone barrier assembly (180) for collection by the harvester (100). The slope of the stone barrier plate (182) and the addition of the rearward extending stone barrier extension (184) are sufficient to allow lighter crop material to pass over the stone barrier assembly (180) while providing sufficient resistance to rocks and other debris to prevent passage of the debris over and beyond the stone barrier (180). The addition of motion by the stone barrier (180) accelerates the continuous purging of debris from the cutter assembly (114) and increases the purity of the harvested crop. Furthermore, the slope of the stone barrier plate (182) cannot be too close to vertical or too high and the depth of the stone barrier extension (184) should be minimized to enable the crop to pass over the stone barrier assembly (180).

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A combine harvester comprising:
a chassis;
a head including a reel rotating about an axis substantially perpendicular to a direction of travel;
a cutter at a front portion of the head;
a crop feeder system;
a powered movable stone barrier rearward of the cutter.

2. The combine harvester according to claim 1, wherein the crop feeder system comprises a reel.

3. The combine harvester according to claim 2, wherein the crop feeder system comprises a feeder belt proximate the stone barrier.

4. The combine harvester according to claim 1, wherein the cutter comprises a sickle bar.

5. The combine harvester according to claim 4, wherein the stone barrier and the sickle bar are driven in a lateral reciprocating motion.

6. The combine harvester according to claim 4, wherein the head comprises a laterally extending knife guard at a leading edge of the cutter, and wherein the knife guard forms a laterally extending horizontal channel, the sickle bar moving laterally in the channel.

7. The combine harvester according to claim 1, wherein the combine harvester comprises a test plot harvester.

8. The combine harvester according to claim 1, wherein the stone barrier comprises a laterally movable plate having a portion with a rearward and upward sloping upper surface.

9. The combine harvester according to claim 8, wherein the stone barrier comprises a substantially horizontal portion extending rearward from the portion of the plate with a rearward and upward sloping upper surface.

10. The combine harvester according to claim 8, further comprising a stationary end filling element below the stone barrier plate and proximate an end of the stone barrier plate.

11. A harvester head comprising:
a reel rotating about an axis substantially perpendicular to a direction of travel;
a crop transport system for transporting harvested crop deposited by the reel through the head;
a cutter at a front portion of the head;
a crop feeder system;
a powered movable stone barrier rearward of the cutter.

12. The harvester head according to claim 11, wherein the cutter comprises a sickle bar.

13. The harvester head according to claim 12, wherein the head comprises a laterally extending knife guard at a leading edge of the cutter, and wherein the knife guard forms a laterally extending horizontal channel, the sickle bar moving laterally in the channel.

14. The harvester head according to claim 11, wherein the stone barrier comprises a substantially horizontal portion extending rearward from the portion with a rearward and upward sloping upper surface.

15. The harvester head according to claim 12, further comprising a stationary end filling element below the stone barrier plate and proximate an end of the stone barrier plate.

16. A method of harvesting crop with a combine harvester including a rotating reel gathering crops, the combine harvester comprising a movable stone barrier, the method comprising:
advancing the harvester along at least a first crop test plot and a second crop test plot and rotating a reel about a rotational axis to harvest crop;
cutting the crop;
transporting cut crop;
driving the stone barrier laterally in a reciprocating motion;
delivering material passing over the stone barrier for further handling.

17. The method of harvesting crop according to claim 16, wherein cutting the crop comprises cutting the crop with a reciprocating cutter, the method further comprising driving the reciprocating cutter and the stone barrier together.

18. The method of harvesting crop according to claim 16, wherein cutting the crop comprises cutting the crop with a reciprocating cutter, the method further comprising driving the reciprocating cutter and the stone barrier together with a single driver.

19. The method of harvesting crop according to claim 16, wherein the head comprises a laterally extending knife guard at a leading edge of the cutter, and wherein the knife guard forms a laterally extending horizontal channel, the method comprising moving the sickle bar laterally in the channel.

20. The method of harvesting crop according to claim 16, wherein the stone barrier comprises a substantially horizontal portion extending rearward from the portion with a rearward and upward sloping upper surface.
